(19) United States
(12) Patent Application Publication
(10) Pub. No.: US 2023/0143641 A1
(43) Pub. Date: May 11, 2023

(54) AN AGROCHEMICAL COMPOSITION

(71) Applicant: UPL LTD, Mumbai (IN)

(72) Inventors: Achintya Mondal, Mumbai (IN); Satish Ekanath Bhoge, Mumbai (IN)

(21) Appl. No.: 17/907,810

(22) PCT Filed: Feb. 18, 2021
(86) PCT No.: PCT/IB2021/051368

§ 371 Date: Aug. 29, 2022

(30) Foreign Application Priority Data
Feb. 29, 2020 (IN) 202021008723

(51) Int. Cl. A01N 57/20; A01N 25/30; A01P 13/00

(52) U.S. Cl. CPC A01N 57/20; A01N 25/30; A01P 13/00

(57) ABSTRACT

The present invention relates to an agrochemical composition for improving the effectiveness of an herbicide, such as glyphosate and glufosinate, using non-ionic surfactants and electrolytes in order to enhance stomatal penetration. Also provided is a method of controlling undesirable plants using said compositions.

### FIELD OF THE INVENTION

The present invention relates to an agrochemical composition for improving the effectiveness of an herbicide. The present invention more particularly relates to an agrochemical composition for improving the effectiveness of an herbicide using non-ionic surfactants and electrolytes.

### BACKGROUND OF THE INVENTION

Weeds are among the crop pests and they reduce crop economic yield by 10 to 15% yearly, according to the Food and Agriculture Organization of the United Nations. Meanwhile, weeds are also the hosts of various crop pests and pathogens. Herbicides with different sites of action are by far the most effective weed control tools developed, killing 90 to 99% of the weeds targeted. Undesirable vegetation, which inhibits crop growth, is a constantly recurring problem in agriculture. To solve this problem, researchers are trying to produce an extensive variety of chemicals and chemical formulations effective in the control of such undesirable growth. Modern herbicides, widely classified as pre- and post-emergent herbicides have been used in the world, with significant contributions to an increased crop yield and food quality. While pre-emergent herbicides work to prevent weeds from ever growing, post-emergent herbicides work on weeds that have already grown. The foliar application and the application through soil defines the nature of herbicide action.

Leaves are the primary sites of entry for most foliar-applied herbicides. The process that drives herbicide absorption through leaf is simple diffusion followed by penetration and translocation. When the spray droplet lands on the leaf surface it places a high concentration of the chemical on the leaf surface. Chemicals move from areas of high concentration to low concentration, thus as soon as the spray droplet contacts the leaf, absorption of the chemical begins.

To enter the leaf, herbicides must first penetrate the waxy cuticle (primary barrier to absorption) or other specialized cells on the leaf surface. The cuticle is a layer of overlapping waxy platelets. The cuticle covers the above ground portion of the plant and prevents water and nutrient losses from the plant. As well as protecting the plant front internal losses, the cuticle also prevents some chemicals from entering the plant although others may move through with relative ease. The variability in chemical penetration is a result of the chemical makeup of the cuticle.

Guard cells around stomates, cells surrounding hairs, and cells overlying veins are also responsible for herbicide absorption. Stomata penetration is generally more rapid than cuticular penetration. The stomata are minute pores on the surface of leaves that allow gas exchange between the internal and external environment. Stomata opening and closure is regulated by the plant and can be affected by light, heat, wind, chemicals and other factors. The degree of stomatal entry by an herbicide is dependent on the number and size of the stomata, whether they are open or closed, and on the surface tension of the herbicide. Larger and more numerous stomata allow faster foliar uptake and closed stomata exclude liquids and gases. Chemicals or sprays with high surface tensions (like water) enter the stomata less rapidly than those with low surface tensions.

Stomatal movements are brought about by changes in the turgor pressure of the guard cells which result from fluxes of cations. The principal route of cation entry during stomatal opening appears to be via a cation channel which has selectivity for Li⁺>Na⁺>Cs⁺>K⁺>Rb⁺. The ionic responses of stomata and the different monovalent cations supports stomatal opening and hence can be utilized as an entry to the herbicides.

Surfactants are expected to further improve the bioefficacy of herbicides. Surfactants are either mixed within the formulation of herbicidally active ingredient or supplied separately as an adjuvant to be sprayed along with the formulation. Surfactants may also be applied as tank mix partner or sprayed before herbicide application as wetting/sticking agent. Surfactants are included within the formulation due to various purposes e.g. it may alter the physical characteristics of the spray solution by acting as compatibility agents, buffering agents, antifoam agents, spreading agent, sticking agents and drift control agents. Sometimes, they enhance postemergence herbicide performance by increasing herbicide absorption into plant tissue, provides rain fastness, decreases photodegradation of the herbicide. Surfactants primarily reduces the surface tension between the spray droplet and the leaf surface. Surfactants are broadly classified as non-ionic, anionic, cationic, and amphoteric surfactants.

For the reasons given, there is a need for an agrochemical solution which permit the quick entry of herbicides in the plant for the desired action by developing a stable composition, these compositions being highly active and promoting an increase in the uptake of systemic active ingredients, and allowing combinability with surfactants and electrolyte ingredients, and having the properties that are advantageous from an applications standpoint, such as, for example, good storage stability and uniform and high biological activity. It would therefore be ideal to use non-ionic surfactants along with electrolytes in order to enhance stomatal penetration.

### OBJECTS OF THE INVENTION

Accordingly, it is a primary object of the present invention to provide an agrochemical composition having enhanced herbicidal action.

Another object of the present invention is to provide an agrochemical composition comprising herbicide, non-ionic surfactant and electrolyte, said composition has an enhanced herbicidal action.

Yet another object of the present invention is to provide a process for preparing an agrochemical composition comprising herbicide, non-ionic surfactant and electrolyte.

Still another object of the present invention is to provide a method of controlling undesirable vegetation by using an agrochemical composition comprising herbicide, non-ionic surfactant and electrolyte.

Additional objects and advantages of the invention will be set forth in part in the description which follows, and in part will be obvious from the description, or may be learned by practice of the invention, the objects and advantages being realized and attained by means of the methods, processes, and improvements disclosed in the present invention.

### SUMMARY OF THE INVENTION

In an aspect of the invention, an agrochemical composition for improving the effectiveness of an herbicide comprises:
a) at least one herbicide, its salt, isomer or derivative;
b) at least one non-ionic surfactant; and
c) at least one electrolyte.

In another aspect of the present invention, an agrochemical composition for improving the effectiveness of an herbicide comprises:
a) at least one herbicide, its salt, isomer or derivative;
b) at least one non-ionic surfactant; and
c) at least one electrolyte;

wherein electrolyte is selected from alkali or alkaline earth metal salts.

In another aspect of the present invention, an agrochemical composition for improving the effectiveness of an herbicide comprises:
a) at least one herbicide, its salt, isomer or derivative;
b) at least one non-ionic surfactant;
c) at least one electrolyte; and
d) an anionic surfactant,

wherein electrolyte is selected from alkali or alkaline earth metal salts.

In yet another aspect of the present invention, a method of controlling undesirable plants, said method comprises applying to the plants or to their locus an herbicidally effective amount of an agrochemical composition comprising at least one herbicide, its salt, isomer or derivative; at least one non-ionic surfactant; and at least one electrolyte for improving the effectiveness of an herbicide.

In another aspect of the present invention, use of an agrochemical composition comprising at least one herbicide, its salt, isomer or derivative; at least one non-ionic surfactant; and at least one electrolyte for improving the effectiveness of an herbicide according to the present invention.

In another aspect of the present invention, a kit comprising agrochemical composition comprising at least one herbicide, its salt, isomer or derivative; at least one non-ionic surfactant; and at least one electrolyte for improving the effectiveness of an herbicide according to the present invention.

### DETAILED DESCRIPTION OF THE INVENTION

Inventors of the present invention surprisingly found that co-application of an electrolyte and non-ionic surfactant with at least one herbicide results in fast and better and in some cases long-lasting control of undesirable plant growth. Inventors of the present invention surprisingly observed that upon foliar application of an agrochemical composition of the present invention, the electrolyte dissociates into free ions and; non-ionic surfactants facilitate passage of free ions through root and shoot transport system. This in-turn results into higher concentration of free ions in the stomatal cell's intrinsic environment. The higher concentration of free ions triggers opening of stomata. The opened stomata facilitate efficient uptake of herbicide from leaves surface. This leads to more effective and fast control of undesirable vegetation as compared to the compositions without electrolyte and non-ionic surfactant combinations.

The present invention results into an agrochemical composition which is herbicidally effective due to enhanced uptake of herbicide through stomatal opening.

The combination of electrolyte and non-ionic surfactants in the present invention enhances herbicidal effect through open stomata and leads to more quick and effective control of undesirable vegetation.

The term “herbicidally effective amount” is that quantity of herbicide(s), when applied, will provide the required control of weeds. The selection of the proper quantity to be applied, however, is within the expertise of one skilled in the art.

It must be noted that, as used in this specification, the singular forms “a,” “an” and “the” include plural referents unless the content clearly dictates otherwise. The terms “preferred” and “preferably” refer to embodiments of the invention that may afford certain benefits, under certain circumstances.

Therefore, according to an embodiment of the present invention, an agrochemical composition for improving the effectiveness of an herbicide comprises:
a) at least one herbicide, its salt, isomer or derivative;
b) at least one non-ionic surfactant; and
c) at least one electrolyte.

According to another embodiment of the present invention, an agrochemical composition for improving the effectiveness of an herbicide comprises:
a) at least one herbicide, its salt, isomer or derivative;
b) at least one non-ionic surfactant; and
c) at least one electrolyte,

wherein electrolytes are selected from alkali or alkaline earth metal salts.

According to another embodiment of the present invention, an agrochemical composition comprises an herbicide, its salt or derivative.

According to another embodiment of the present invention, an agrochemical composition comprises of an herbicide selected from one or more of

a) organophosphorous herbicides including glyphosate and glufosinate;

b) nitrophenyl ether compounds including oxyfluorfen and fomesafen;

c) aryloxyphenoxypropionic herbicides including haloxyfop, clodinafop and quizalofop;

d) chloroacetanilide herbicides including metolachlor, s-metolachlor, acetolachlor and pretilachlor;

e) sulfonylurea herbicides including metsulfuron and bensulfuron;

f) imidazolinone herbicides including imazapyr and imazethapyr; and

salts, isomers and derivatives of any of them.

According to another embodiment of the present invention, an agrochemical composition comprises of glufosinate in the form of its salts, isomers, mixture of isomers or derivatives.

According to an embodiment of the present invention, glufosinate is selected from its lower alkyl esters thereof or salts with acids or bases such as its hydrochloride salt, monosodium salt, disodium salt, monopotassium salt, dipotassium salt, ammonium salt, —NH3(CH3)+ salt, —NH2(CH3)2+ salt, —NH(CH3)3+ salt, —NH(CH3)2(C2H4OH)+ salt, —NH2(CH3)(C2H4OH)+ salt, or its methyl ester, ethyl ester, propyl ester or butyl ester.

In another embodiment of the present invention the composition comprises a water-soluble inorganic or organic salt of glufosinate, preferably ammonium salt of glufosinate.

According to another embodiment, an agrochemical composition comprises of D-glufosinate or its salts.

According to another embodiment, an agrochemical composition comprises of L-glufosinate or its salts.

According to another embodiment, an agrochemical composition comprises of L-glufosinate salts with ammonium, potassium, sodium ions and the like.

According to another embodiment, an agrochemical composition comprises of L-glufosinate ammonium.

In another embodiment herbicide is glyphosate isopropyl ammonium.

According to an embodiment of the present invention, the agrochemical composition comprises from about 0.1% to about 90% w/w and preferably from about 1% to about 70% w/w herbicide of the total weight of the herbicidal composition.

According to a preferred embodiment of the present invention, the agrochemical composition comprises from about 10% to about 50% w/w herbicide of the total weight of the herbicidal composition.

According to an embodiment of the present invention, the agrochemical composition comprises from about 0.1% to about 90% w/w and preferably from about 1% to about 70% w/w glufosinate or its salt, isomer or derivative of the total weight of the herbicidal composition.

According to a preferred embodiment of the present invention, the agrochemical composition comprises from about 10% to about 50% w/w glufosinate or its salt, isomer or derivative of the total weight of the herbicidal composition.

According to a preferred embodiment of the present invention, the agrochemical composition comprises from about 70% to about 90% L-glufosinate of the total weight of the herbicidal composition.

According to an embodiment of the present invention, an agrochemical composition for improving the effectiveness of an herbicide comprises of at least one non-ionic surfactant.

According to an embodiment of the present invention, non-ionic surfactant is selected from one or more of alcohol ethoxylate, alkylpolyglucoside, alkylamine oxide, alkyl glucamide, fatty acid methyl ester, sorbitan fatty acid ester and ethoxylated sorbitan ester, ethoxylated alkylphenol, ethoxylated tristyrylphenol and alkyl amide.

According to an embodiment of the present invention, non-ionic surfactant from alcohol ethoxylates type are selected from one or more of C8-20 ethoxylated alcohols such as Tomadol 1-5 (11 carbon 5 mole) linear alcohol ethoxylated, Tomadol 1-7 (11 carbon 7 mole) linear alcohol ethoxylated, Surfonic L12-6 (12 carbon 6 mole) linear alcohol ethoxylated, Surfonic DDA6 (6 mole) branched alcohol ethoxylate, Surfonic TDA6 (6 mole) tridecyl alcohol branched alcohol ethoxylate, Surfonic OP-70 7 mole octylphenol ethoxylated, Tergitol NP-6 (6 mole) nonylphenol ethoxylated, Trylox 5902 (16 mole) castor oil ethoxylated fatty acids, Span 80 sorbitan laurate, Tween 80/polysorbate 80 sorbitan oleate and Surfonic L24-5 (24 carbon 5 mole) linear alcohol ethoxylated linear alcohol.

According to an embodiment of the present invention, alkylpolyglucoside type non-ionic surfactants are selected from one or more of alkylpolyglucosides containing an alkyl group having 6 to 30 carbon atoms and preferably 8 to 16 carbon atoms, and containing a glucoside group preferably comprising 1.2 to 3 glucoside units. The alkylpolyglucosides may be chosen for example from decylglucoside (C9-C11 alkyl-glucoside) such as the product marketed under the name Mydol 10® by Kao Chemicals or Plantacare 2000 UP® by the Cognis), caprylyl/capryl glucoside (Plantacare KE 3711® by Cognis), laurylglucoside (Plantacare 1200 UP® by Cognis), cocoglucoside (Plantacare 818 UP® by Cognis), caprylylglucoside (Plantacare 810 UP® by Cognis), and their mixtures.

According to an embodiment of the present invention, non-ionic surfactant from alkylamine oxide type is selected from one or more of alkyl N, N-dimethylamine N-oxide type surfactant wherein the alkyl group is a C₈-C₂₀ carbon chain alkyl group. Examples of (C₈-C₂₀)alkyl dimethylamine N-oxide include decyl-, dodecyl, tetradecyl-, pentadecyl-, and hexadecyl N,N-dimethylamine oxides such as decylamine oxide, myristylamine/dimethylamine oxide, Dodecyldimethylamine oxide.

According to preferred embodiment of the present invention, alkylamine oxide is decylamine oxide.

According to an embodiment of the present invention, non-ionic surfactant from alkylglucamide type is selected from one or more of D-Glucitol, 1-deoxy-1-(methylamino)-,N—C8-10 acyl derivs, N-methyl-N-octanoyl/decanoylglucamine, Capryloyl/Caproyl Methyl Glucamide, dodecyl-N-methylglucamide, dodecyltetradecyl-N-methylglucamide, and cetylstearyl-N-methylglucamide.

According to preferred embodiment of the present invention, the alkylglucamide is D-Glucitol, 1-deoxy-1-(methylamino)-,N—C8-10 acyl derivs.

According to an embodiment of the present invention, non-ionic surfactant from sorbitan fatty acid ester type is selected from one or more of polysorbate 20, polysorbate 60, polysorbate 65, and polysorbate 80. Polysorbate 20, 60, 65 and 80 utilize lauric, stearate (mono), stearate (tri) and oleate, respectively, for the fatty acid portion of the molecule.

According to an embodiment of the present invention, the agrochemical composition comprises from about 0.1% to about 50% w/w and preferably from about 1% to about 40% w/w non-ionic surfactants of the total weight of the herbicidal composition.

According to a preferred embodiment of the present invention, the agrochemical composition comprises from about 5% to about 30% w/w non-ionic surfactants of the total weight of the herbicidal composition.

According to another embodiment of the present invention, an agrochemical composition for improving the effectiveness of an herbicide comprises of at least one electrolyte.

According to another embodiment of the present invention, an agrochemical composition for improving the effectiveness of an herbicide comprises of at least one electrolyte selected from one or more of alkali and alkaline earth metal salts thereof.

According to another embodiment of the present invention, an agrochemical composition for improving the effectiveness of an herbicide comprises of at least one electrolyte selected from one or more of inorganic salts of alkali and alkaline earth metal.

According to another embodiment of the present invention, alkali or alkaline earth metal based electrolyte is selected from one or more of magnesium chloride, magnesium sulfate, potassium chloride, potassium sulfate, potassium carbonate, sodium chloride, sodium carbonate, sodium chlorate, sodium nitrate, sodium sulfate, calcium chloride, calcium carbonate and calcium nitrate.

According to another embodiment of the present invention, alkali or alkaline earth metals-based electrolyte is selected from one or more of magnesium chloride, magnesium sulfate, potassium chloride, sodium chloride and sodium nitrate.

According to an embodiment of the present invention, the agrochemical composition comprises from about 0.01% to about 30% w/w and preferably from about 0.1% to about 20% w/w electrolyte of the total weight of the agrochemical composition.

According to a preferred embodiment of the present invention, the agrochemical composition comprises from about 0.1% to about 10% w/w electrolyte of the total weight of the agrochemical composition.

In another aspect of the present invention, an agrochemical composition for improving the effectiveness of an herbicide comprises:
a) at least at least one herbicide, its salt, isomer or derivative;
b) at least at least one non-ionic surfactant;
c) at least at least one electrolyte; and
d) an anionic surfactant,

wherein electrolyte is selected from alkali or alkaline earth metal salts.

According to an embodiment of the present invention, an agrochemical composition for improving the effectiveness of an herbicide comprises of at least at least one anionic surfactant.

According to an embodiment of the present invention, the agrochemical composition further comprises of anionic surfactant selected from one or more of linear alkylbenzene sulfonates, alkyl ester sulfonates, alkyl sulfates, alkyl alkoxy sulfates, alkyl sulfonates, alkyl aryl ether sulfates, alkyl napthalene sulfonates, sulfosuccinates, and taurates, as well as mixtures thereof.

According to an embodiment of the present invention, the anionic surfactants are selected from one or more of sodium lignosulfonate, sodium dodecyl benzenesulfonate, naphthalene sulfonate condensate, ammonium lauryl sulfate, ammonium laureth sulfate, triethylamine lauryl sulfate, triethylamine laureth sulfate, triethanolamine lauryl sulfate, triethanolamine laureth sulfate, monoethanolamine lauryl sulfate, monoethanolamine laureth sulfate, diethanolamine lauryl sulfate, diethanolamine laureth sulfate, lauric monoglyceride sodium sulfate, sodium lauryl sulfate (also known as sodium dodecyl sulfate), sodium laureth sulfate (sodium lauryl ether sulfate), potassium lauryl sulfate, potassium laureth sulfate, ammonium lauryl sulfate, sodium cocyl sulfate, sodium trideceth sulfate, sodium tridecyl sulfate, ammonium trideceth sulfate, ammonium tridecyl sulfate, potassium lauryl sulfate, monoethanolamine cocyl sulfate and sodium tridecyl benzene sulfonate.

According to preferred embodiment of the present invention, the anionic surfactant is selected from one or more of sodium lauryl sulfate, sodium laureth sulfate, sodium dodecyl benzenesulfonate and naphthalene sulfonate condensate.

According to an embodiment of the present invention, the agrochemical composition comprises from about 0.1% to about 50% w/w and preferably from about 1% to about 40% w/w anionic surfactants of the total weight of the herbicidal composition.

According to a preferred embodiment of the present invention, the agrochemical composition comprises from about 5% to about 30% w/w anionic surfactants of the total weight of the herbicidal composition.

According to an embodiment of the present invention, an agrochemical composition for improving the effectiveness of an herbicide may further comprise—one or more herbicides. Examples of herbicides which may be used in combination with glufosinate in accordance with the present invention include herbicides or their salts such as lactofen, fomesafen, oxyfluorfen and their salts, Pyrimidinyloxybenzoic analogue herbicides such as pyrithiobac sodium, bispyribac sodium, bilanafos and their salts, bialaphos and its salts; chloroacetanilide herbicide such as acetolachlor, pretilachlor, metolachlor, Bipyridinium herbicides such as paraquat and diquat and salts thereof; aryloxyphenoxyacetic acid herbicide such as clodinafop, haloxyfop and their derivatives; aryloxyalkanoic acid herbicides such as 2, 4-D and its salts, MCPA and its salts, MCPB and its salts; Pyridine herbicides such as triclopyr, picloram, aminopyralid and salts thereof; Aromatic herbicides such as dicamba, 2,3,6-TBA, tricamba and their salts; Pyridinecarboxylic acid herbicides such as clopyralid; Imidazolinones selected from imazameth, imazamethabenz, imazamox, imazapic, imazapyr, imazaquin, imazethapyr or mixtures of such herbicides or salts thereof.

According to an embodiment of the present invention, the agrochemical composition may optionally comprise further customary formulating assistants such as solvents, inert materials, such as stickers, wetters, binders, stabilizers, dispersants, emulsifiers, penetrants, preservatives, fillers, carriers and colorants, and pH modifiers (buffers, acids and bases) or viscosity modifiers (e.g., thickeners), and optionally also defoamers.

According to an embodiment of the present invention, the agrochemical composition comprises polar or nonpolar organic solvents or polar or nonpolar inorganic solvents or mixtures thereof.

Non-limiting examples of nonpolar solvents according to the present invention include aliphatic or aromatic hydrocarbons, such as mineral oils or toluene, xylenes, and naphthalene derivatives, halogenated aliphatic or aromatic hydrocarbons such as methylene chloride or chlorobenzene, oils, plant-based oils such as corn germ oil and rapeseed oil, for example, or oil derivatives such as rapeseed oil methyl ester.

Non-limiting examples of polar solvents according to the present invention include polar ethers such as tetrahydrofuran (THF), dioxane, alkylene glycol monoalkyl and dialkyl ethers such as, for example, propylene glycol monomethyl ether, propylene glycol monoethyl ether, ethylene glycol monomethyl ether or monoethyl ether, ethylene glycol butyl ether (cellosolve); alcohols such as methanol, ethanol, n- and isopropanol, n-, iso-, tert- and 2-butanol; diglyme and tetraglyme; amides such as dimethylformamide (DMF), dimethylacetamide, dimethylcaprylamide, dimethylcapramide and N-alkylpyrrolidones; ketones such as acetone; fatty acid based methyl ester (methyl palmitate/oleate), esters based on glycerol and carboxylic acids, such as glycerol mono-, di- and triacetate; lactams; lactate esters having chain lengths of 1 to 10 C atoms in the ester moiety; carbonic diesters; nitriles such as acetonitrile, propionitrile, butyronitrile, and benzonitrile; sulfoxides and sulfones such as dimethyl sulfoxide (DMSO), sulfolane and polycarbonate solvents.

Suitable binders are selected from one or more of polyvinyl pyrrolidone, polyethylene glycol, polyethylene oxide, polyethoxylated fatty acids, polyethoxylated alcohols, natural gums, lignosulphonate and the like.

Suitable stabilizers are selected from one or more of hexamethylenetetramine, formaldehyde, orthoesters and epoxides.

Suitable defoamers are selected from one or more of fatty acid alkyl ester alkoxylates, organopolysiloxanes such as polydimethylsiloxanes and mixtures thereof with microfine, optionally silanized silica, perfluoroalkylphosphonates, perfluoroalkylphosphinates, paraffins, waxes and microcrystalline waxes and mixtures thereof with silanized silica or mixtures of different foam inhibitors.

Suitable preservatives are selected from one or more organic acids and their esters, examples being ascorbic acid, ascorbyl palmitate, sorbate, benzoic acid, methyl 4-hydroxybenzoate, propyl 4-hydroxybenzoate, propionates, phenol, 2-phenyl phenate, 1,2-benzisothiazolin-3-one, formaldehyde, sulfurous acid, and salts thereof.

Suitable drift retardants are selected from one or more water-soluble polymers, as for example polyacrylamides, acrylamide/acrylic acid polymers, sodium polyacrylate, carboxymethylcellulose, hydroxyethylcellulose, methylcellulose, polysaccharides, and natural and synthetic guar gum. It is also possible, furthermore, for certain emulsions or self-emulsifying systems to be used as drift retardants.

According to an embodiment of the present invention, the agrochemical composition comprises from about 0.01% to about 50% w/w and preferably from about 1% to about 40% w/w customary formulating assistants of the total weight of the agrochemical composition.

According to a preferred embodiment of the present invention, the agrochemical composition comprises from about 5% to about 30% w/w customary formulating assistants of the total weight of the agrochemical composition.

In an embodiment of the present invention, a stable agrochemical composition comprises from about 0.1% to about 90% w/w herbicide, from about 0.1% to about 50% w/w non-ionic surfactant, from about 0.01% to about 30% w/w electrolyte of the total weight of the agrochemical composition.

In an embodiment of the present invention, a stable agrochemical composition comprises from about 1% to about 70% w/w herbicide, from about 1% to about 40% w/w non-ionic surfactant, from about 0.1% to about 20% w/w electrolyte of the total weight of the agrochemical composition.

In a preferred embodiment of the present invention, a stable agrochemical composition comprises from about 10% to about 50% w/w herbicide, from about 1% to about 30% w/w non-ionic surfactant, from about 0.1% to about 10% w/w electrolyte of the total weight of the agrochemical composition.

According to an embodiment of the present invention, a stable agrochemical composition comprising a herbicide, non-ionic surfactant and electrolyte may be formulated as liquid formulations such as Emulsifiable Concentrate (EC), Micro Emulsion (ME), Soluble Liquid (SL), Suspension Concentrate (SC) or as solid formulations such as Wet Granules (WG), Soluble Granules (SG), Dry Flowable (DF), broadcasting granules or other suitable formulation.

In a preferred embodiment of the present invention, a stable agrochemical composition comprises a herbicide, non-ionic surfactant and electrolyte may be formulated as soluble liquid (SL).

In a preferred embodiment of the present invention, a stable agrochemical composition comprising from about 10% to about 50% w/w herbicide, from about 1% to about 30% w/w non-ionic surfactant, from about 0.1% to about 10% w/w electrolyte of the total weight of the agrochemical composition is formulated as soluble liquid (SL).

In another preferred embodiment of the present invention, a stable agrochemical composition comprising from about 10% to about 50% w/w glufosinate ammonium, from about 1% to about 30% w/w alkyl glucamide, from about 1% to about 30% w/w alkyl amine oxide, from about 1% to about 30% w/w glycol ether, from about 0.1% to about 10% w/w potassium chloride of the total weight of the agrochemical composition is formulated as soluble liquid (SL).

In another preferred embodiment of the present invention, a stable agrochemical composition comprising from about 10% to about 50% w/w herbicide, from about 1% to about 30% w/w alkyl glucamide, from about 1% to about 30% sodium lauryl ether sulfate, from about 1% to about 30% glycol ether and from about 0.1% to about 10% w/w sodium chloride of the total weight of the agrochemical composition is formulated as soluble liquid (SL).

According to an embodiment of the present invention, the agrochemical composition for improving the effectiveness of an herbicide may be formulated in a suitable formulation using conventional process of preparing the agrochemical composition.

According to an embodiment of the present invention, a method of controlling undesirable plants, said method comprises applying to the plants or to their locus an herbicidally effective amount of an agrochemical composition comprising at least at least one herbicide, its salt or derivative; at least at least one non-ionic surfactant; and at least at least one electrolyte for improving the effectiveness of an herbicide.

According to an embodiment of the present invention, a method to control undesirable plants or to influence the growth of plants, said method comprises applying to the plants or to their locus an effective amount of agrochemical composition comprising at least at least one herbicide, its salt or derivative; at least at least one non-ionic surfactant; and at least at least one electrolyte for improving the effectiveness of an herbicide.

In an embodiment of the present invention, a method to control undesirable plants or to influence the growth of plants, said method comprises applying to the plants or to their locus an effective amount of agrochemical composition comprising glufosinate ammonium; at least at least one non-ionic surfactant; and at least at least one electrolyte for improving the effectiveness of an herbicide.

In another aspect of the present invention, use of an agrochemical composition comprising at least at least one herbicide, its salts and derivatives; at least at least one non-ionic surfactant; and at least at least one electrolyte for improving the effectiveness of an herbicide according to the present invention.

According to an embodiment of the present invention, the agrochemical composition is designed to be diluted with water (or a water-based liquid) to form the corresponding end-use agrochemical formulations, typically spray formulations.

According to an embodiment of the present invention, the agrochemical composition requires a formulation which allows the active compounds to be taken up by the weeds and undesirable plants.

According to an embodiment of the present invention, the agrochemical composition is used as the source of active agrochemical ingredients and will typically be diluted to form end-use formulations, typically spray formulations. The dilution may be with water at from 1 to 10,000, particularly 10 to 1,000 times the total weight of the agrochemical composition to form the spray formulation. In said diluted composition, the agrochemical active concentration may be in the range from about 0.001 wt. % to about 1 wt. % of the total formulation as sprayed.

Spray formulations include all the components which are required to apply to the plants or their environment. Spray formulations can be made up by simple dilution of agrochemical composition containing agrochemically active ingredients (herbicide), or by mixing of the individual herbicide, or a combination of diluting an herbicide and adding further individual herbicides or mixtures of herbicides. Typically, such end use mixing is carried out in the tank from which the formulation is sprayed, or alternatively in a holding tank for filling the spray tank. Such mixing and mixtures are typically termed tank mixing and tank mixtures.

In another aspect of the present invention, a kit comprising agrochemical composition comprises at least at least one herbicide, its salt and derivative; at least at least one non-ionic surfactant; and at least at least one electrolyte for improving the effectiveness of an herbicide according to the present invention.

In one embodiment of the invention, the kits may include one or more, including all, components that may be used to prepare an agrochemical composition. For example, kits may include active ingredients, non-ionic surfactants and electrolyte. One or more of the components may already be combined together or pre-formulated. In those embodiments where more than two components are provided in a kit, the components may already be combined together and as such are packaged in a single container such as a vial, bottle, can, pouch, bag or canister.

In other embodiments, two or more components of a kit may be packaged separately, i. e., not pre-formulated. As such, kits may include one or more separate containers such as vials, cans, bottles, pouches, bags or canisters, each container containing a separate component for agrochemical composition.

In both forms, a component of the kit may be applied separately from or together with the further components or as a component of a combination composition according to the invention for preparing the agrochemical composition according to the invention.

In an embodiment of the present invention, the agrochemical composition comprising (a) herbicide, (b) non-ionic surfactants, and (c) electrolyte, is in the form of a kit with single pack or multi pack.

In a preferred embodiment of the present invention, the agrochemical composition comprising (a) glufosinate-ammonium, (b) non-ionic surfactants, and (c) electrolyte is in the form of a kit with single pack or multi pack.

The composition described above is herbicidally efficacious and is stable. It has been found that the anionic surfactants of the stable agrochemical composition of the present invention provides excellent stability over time and at various temperatures, and even when the stable agrochemical composition undergoes shear forces for example on mixing. Also, the stable agrochemical composition obtained by the process have superior suspensibility, better dispersibility, very low or no sedimentation and minimal particle degradation.

All the features described herein may be combined with any of the above aspects, in any combination.

In order that the present invention may be more readily understood, reference will now be made, by way of example, to the following description. It will be understood that all tests and physical properties listed have been determined at atmospheric pressure and room temperature (i.e. 25° C.), unless otherwise stated herein, or unless otherwise stated in the referenced test methods and procedures.

### Example 1: Preparation of Glufosinate Ammonium 280 g/L Soluble Liquid (SL)

| Ingredients | Quantity (% w/w) |
|---|---|
| Glufosinate ammonium | 25 |
| Alkyl glucamide | 5 |
| Alkyl polyglucoside | 3 |
| Alkyl amine oxide | 24 |
| Glycol ether (solvent) | 3 |
| Potassium chloride | 5 |
| DM Water | Q.S. |

Required quantity of water was taken into mixing vessel. 25 g glufosinate ammonium was added to the mixing vessel and stirred at 25-40° C. 5 g potassium chloride was added to the mixing vessel and continued stirring for 30 minutes. Subsequently, 5 g alkyl glucamide, 3 g alkyl polyglucoside, 24 g alkyl amine oxide and 3 g glycol ether and required quantity of water was added to the vessel to obtain mixture. The mixture was then filtered and packed in a suitable packaging.

### Examples 2-14

| | Examples | | | | | | | | | | | | |
|---|---|---|---|---|---|---|---|---|---|---|---|---|---|
| | 2 | 3 | 4 | 5 | 6 | 7 | 8 | 9 | 10 | 11 | 12 | 13 | 14 |
| Ingredients | 280 g/L | | | | 200 g/L | | | | | | 150 g/L | | |
| Glufosinate ammonium | 25 | 25 | 25 | 25 | 18.5 | 18.5 | 18.5 | 18.5 | 18.5 | 18.5 | 13.5 | 13.5 | |
| L-Glufosinate | — | — | — | — | — | — | — | — | — | — | — | — | 13.5 |
| (50% aqueous solution) | | | | | | | | | | | | | |
| Alkyl glucamide | 5 | 5 | 5 | 5 | 6 | — | — | — | — | 6 | 5 | 5 | 5 |
| Alkyl polyglucamide | — | — | — | — | — | 8 | — | — | — | — | — | — | — |
| Alkyl polyglucoside | — | 3 | — | 3 | — | — | 8 | 8 | 8 | — | — | — | — |
| Alkyl amine oxide | | 24 | 24 | 24 | | 24 | 24 | 24 | 24 | — | — | — | — |
| Sodium lauryl ether sulfate | 24 | — | — | — | 23 | — | — | — | — | 23 | 20 | 20 | 20 |
| (Alkyl ether sulfate) | | | | | | | | | | | | | |
| Glycol ether (solvent) | 3 | 3 | 3 | 3 | 4 | 3 | 3 | 3 | 3 | 4 | 3 | 3 | 3 |
| Potassium chloride | 3 | | 3.5 | | 5 | 5 | | | | 5 | 5 | | 5 |
| Magnesium chloride | — | 3 | — | — | — | — | — | — | — | — | — | — | — |
| Sodium chloride | — | — | — | 3.5 | — | — | — | — | — | — | — | — | — |
| Calcium chloride | — | — | — | — | — | — | 3 | — | — | — | — | — | — |
| Magnesium sulfate | — | — | — | — | — | — | — | 3.5 | — | — | — | — | — |
| Potassium sulfate | — | — | — | — | — | — | — | — | — | 3 | — | — | — |
| Sodium sulfate | — | — | — | — | — | — | — | — | — | — | — | — | 3 |
| DM Water | qs | qs | | qs | Qs | qs | qs | Qs | qs | qs | qs | qs | qs |

### Example 15: Preparation of Glufosinate Ammonium 500 g/Kg Dry Flowable (DF)

| Ingredients | Quantity (% w/w) |
|---|---|
| Glufosinate ammonium | 50 |
| Ethoxylated alcohol | 5 |
| Methyl Palmitate/Oleate | 10 |
| Polyvinylpyrrolidone | 2 |
| Potassium chloride | 10 |
| DM Water | Q.S. |

Glufosinate ammonium, alcohol ethoxylate, methyl palmitate/oleate, polyvinylpyrrolidone and potassium chloride were added in above mentioned quantity and blended in a ribbon blender for 20-30 min to obtain blend. The blend was further grounded in air jet mill to obtain grounded mix having particle size D₁₀₀ below 30 micron. The grounded mix for then blended for 40-50 min to obtain homogeneous mixture. The homogeneous mixture was taken to prepare dough using water spray. Granules were then extruded in a granulator. The extruded granules were dried on fluid bed dryer. The dried granules were passed through sieve to obtain uniformly sized granules. Undersized and oversized granules were recycled back. Finished granules were packed in a suitable packaging.

### Example 16: Preparation of Glufosinate Ammonium 500 g/Kg DF

| Ingredients | Quantity (% w/w) |
|---|---|
| Glufosinate ammonium | 50 |
| Alcohol ethoxylate | 6 |
| Methyl palmitate/oleate | 12 |
| Polyvinylpyrrolidone | 2 |
| Potassium chloride | 20 |
| Hexamethylenetetramine | Q.S. |

Glufosinate ammonium, alcohol ethoxylate, methyl palmitate/oleate, polyvinylpyrrolidone, potassium chloride and hexamethylenetetramine were added in a given ratio shown above and the composition was prepared as per the process of Example 15.

### Example 17: Preparation of Glufosinate Ammonium 140 and Glyphosate 180 g/L Soluble Liquid (SL)

| Ingredients | Amount (% w/w) |
|---|---|
| Glufosinate ammonium | 14.5 |
| Glyphosate salt | 18.2 |
| Propylene glycol | 0.5 |
| Alkyl glucamide | 4.0 |
| Sodium lauryl ether sulfate | 20.0 |
| Potassium chloride | 5.0 |
| Water | Q.S. |

Glufosinate ammonium, glyphosate salt, propylene glycol, alkyl glucamide, sodium lauryl ether sulfate and potassium chloride were mixed in water in a given ratio shown above and the composition was prepared as per the process of Example 1.

### Comparative Examples 18-21

### Example 18: Preparation of Glufosinate Ammonium 280 g/L Soluble Liquid (SL)

| Ingredients | Quantity (% w/w) |
|---|---|
| Glufosinate ammonium | 25 |
| Alkyl glucamide | 5 |
| Alkyl polyglucoside | 3 |
| Alkyl amine oxide | 24 |
| Glycol ether (solvent) | 3 |
| DM Water | Q.S. |

Glufosinate ammonium, alkyl glucamide, alkyl polyglucoside, alkyl amine oxide and glycol ether were mixed in water in a given ratio shown above and the composition was prepared as per the process of Example 1.

### Example 19: Preparation of Glufosinate Ammonium 200 g/L Soluble Liquid (SL)

| Ingredients | Quantity (% w/w) |
|---|---|
| Glufosinate ammonium | 18.5 |
| Alkyl glucamide | 8 |
| Alkyl amine oxide | 24 |
| Glycol ether (solvent) | 3 |
| DM Water | Q.S |

Glufosinate ammonium, alkyl glucamide, alkyl amine oxide and glycol ether were mixed in water in a given ratio shown above and the composition was prepared as per the process of Example 1.

### Example 20: Preparation of Glufosinate Ammonium 200 g/L Soluble Liquid (SL)

| Ingredients | Quantity (% w/w) |
|---|---|
| Glufosinate ammonium | 18.5 |
| Alkyl glucamide | 6 |
| Sodium lauryl ether sulfate | 23 |
| Glycol ether (solvent) | 4 |
| DM Water | Q.S |

Glufosinate ammonium, alkyl glucamide, sodium lauryl ether sulfate, glycol ether and potassium chloride were mixed in water in a given ratio shown above and the composition was prepared as per the process of Example 1.

### Example 21: Preparation of Glufosinate Ammonium 150 g/L Soluble Liquid (SL)

| Ingredients | Quantity (% w/w) |
|---|---|
| Glufosinate ammonium | 13.5 |
| Alkyl glucamide | 5 |
| Sodium lauryl ether sulfate | 20 |
| Glycol ether (solvent) | 3 |
| DM Water | Q.S. |

Glufosinate ammonium, alkyl glucamide, sodium lauryl ether sulfate and glycol ether were mixed in water in a given ratio shown above and the composition was prepared as per the process of Example 1.

### Example 22: Preparation of Glyphosate Isopropyl Ammonium 20% w/w SL

| Ingredients | Quantity (% w/w) |
|---|---|
| Glyphosate Isopropyl ammonium | 20 |
| Alkyl glucamide | 6 |
| Sodium lauryl ether sulfate | 23 |
| Glycol ether (solvent) | 4 |
| Potassium chloride | 5 |
| DM Water | Q.S |

Glyphosate isopropyl ammonium, alkyl glucamide, sodium lauryl ether sulfate, potassium chloride and glycol ether were mixed in water in a given ratio shown above and the composition was prepared as per the process of Example 1.

### Example 23: Preparation of Glyphosate Isopropyl Ammonium 20% w/w SL

| Ingredients | Quantity (% w/w) |
|---|---|
| Glyphosate Isopropyl ammonium | 20 |
| Alkyl polyglucoside | 8 |
| Alkyl amine oxide | 24 |
| Glycol ether (solvent) | 3 |
| Calcium chloride | 3 |
| DM Water | Q.S |

Glyphosate isopropyl ammonium, alkyl polyglucoside, alkyl amine oxide, glycol ether and calcium chloride were mixed in water in a given ratio shown above and the composition was prepared as per the process of Example 1.

### Bio-Efficacy Data

Compositions were diluted with water to give a water application rate of 500 L/ha at a typical application rate for glufosinate (300-1000 g/ha) on application to non-crop and crop lands containing a spectrum of mono- and dicotyledonous weed plants which had emerged under natural conditions.

Details of Experiment-I:
a) Treatments: 18
b) Application dose: 908 gm ai/Ha
c) Nozzle type: Flat Fan
d) Plot size: 16 sq.m (4 m×4 m)
e) Test Crop: —Non-crop Land
f) Time of application: Post-emergence
g) Average temperature during application: Minimum 15° C. and Maximum 30° C.
h) Application volume: 500 L/Ha of water
i) Observation days: 14 days after application
j) Treatment details: This study was performed on non-crop land at Vapi, Gujarat, India where the land was predominantly covered by weed plants such as grasses, commelina spp., cyprus spp. and trianthema spp. The study was intended to evaluate the efficiency of an agrochemical composition according to the present invention and to understand the role of electrolyte and non-ionic surfactant in the herbicidal composition.

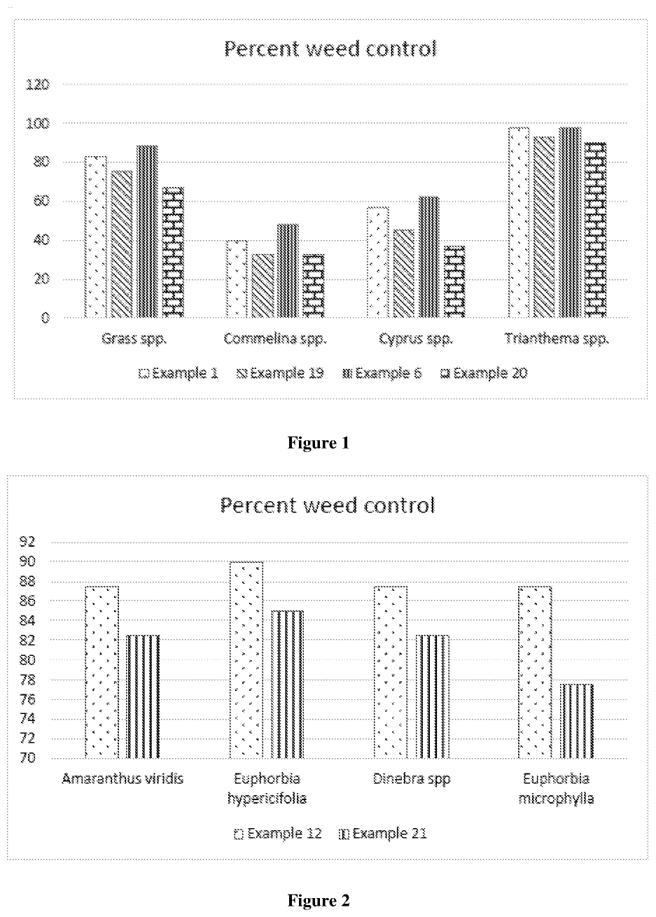

Two compositions (Example-1 and Example-18) of 280 g/L Gf-ammonium were tested against selected weeds. Weed plants were evaluated on 14^{th} day after treatment (Table 1 and FIG. 1), at which time-point, significantly more burn down effect was observed in regions treated with an agrochemical composition of Example-1 comprising both electrolyte and non-ionic surfactant in comparison to an agrochemical composition of Example-18 in which electrolyte was not present. Composition of Example-18 showed 75% control of grass spp., 33% control of commelina spp., 45% control of cyprus spp., and 93% control of trianthema spp. wherein, composition of Example-1 found better in all the selected weeds by controlling around 83% control of grass spp., 40% control of commelina spp., 57% control of cyprus spp. and 98% control of trianthema spp.

Two compositions (Example-6 and Example-19) of 200 g/L Gf-ammonium were tested against selected weeds. Weed plants were evaluated on 14^{th} day after treatment (Table 1 and FIG. 1), at which time-point, significantly more burn down effect was observed in regions treated with an agrochemical composition of Example-6 comprising both electrolyte and non-ionic surfactant in comparison to an agrochemical composition of Example-19 in which electrolyte was not present. Composition of Example-19 showed 67% control of grass spp., 33% control of commelina spp., 37% control of cyprus spp., and 90% control of trianthema spp. wherein, composition of Example-6 found better in all the selected weeds by controlling around 88% control of grass spp., 48% control of commelina spp., 62% control of cyprus spp. and 98% control of trianthema spp.

TABLE 1

| | Percent weed control at 14 DAT | | | |
|---|---|---|---|---|
| | | Commelina | Cyprus | Trianthema |
| Compositions | Grass | spp. | spp. | spp. |
| Example 1 | 83.00 | 40.00 | 57.00 | 98.00 |
| Example 18 | 75.00 | 33.00 | 45.00 | 93.00 |
| Example 6 | 88.00 | 48.00 | 62.00 | 98.00 |
| Example 19 | 67.00 | 33.00 | 37.00 | 90.00 |

Some more weeds were selected to evaluate the efficacy of the compositions according to the present invention.

Details of Experiment-II:
a) Treatments: 18
b) Application dose: 908 gm ai/Ha
c) Nozzle type: Flat Fan
d) Plot size: 9.2 m×3.2 m
e) Test Crop: —Non-crop Land
f) Time of application: Post-emergence
g) Average temperature during application: Minimum 15° C. and Maximum 30° C.
h) Application volume: 450 g a.i/ha of water
i) Observation days: 14 days after application
   Treatment details: This study was performed on grape vineyards at Nashik, Maharashtra, India where the vineyards were predominantly covered by weed plants such as Amaranthus viridis, Euphorbia hypericifolia, dinebra sp and Euphorbia microphylla. The study was intended to evaluate the efficiency of an agrochemical composition according to the present invention and to understand the role of electrolyte and non-ionic surfactant in the herbicidal composition.

Two compositions (Example-12 and Example-20) of 150 g/L Gf-ammonium were tested against selected weeds. Weed plants were evaluated on 14^{th} day after treatment (Table 2 and FIG. 2), at which time-point, significantly more burn down effect was observed in regions treated with an agrochemical composition of Example-12 comprising both electrolyte and non-ionic surfactant in comparison to an agrochemical composition of Example-21 in which electrolyte was not present. Composition of Example-20 showed 82.5% control of Amaranthus viridis, 85% control of Euphorbia hypericifolia, 82.5% control of dinebra spp., and 77.5% control of Euphorbia microphylla wherein, composition of Example-12 found better in all the selected weeds by controlling around 87.5% control of Amaranthus viridis., 90% control of Euphorbia hypericifolia., 87.5% control of dinebra spp. and 87.5% control of Euphorbia microphylla.

TABLE 2

| | Percent weed control at 12 DAT | | | |
|---|---|---|---|---|
| | Amaranthus | Euphorbia | Dinebra | Euphorbia |
| Compositions | viridis | hypericifolia | spp | microphylla |
| Example 12 | 87.50 | 90.00 | 87.50 | 87.50 |
| Example 20 | 82.50 | 85.00 | 82.50 | 77.50 |

Evaluation of the effect after two weeks revealed that the green parts of the weed plants had died and therefore that control of the weed plants was effective. Therefore, it was concluded that the agrochemical composition for improving the effectiveness of an herbicide comprising electrolyte and non-ionic surfactant showed far more superior effect on commonly found weeds of non-crop lands as well as crop lands viz grasses, commelina spc., cyprus spc., triantham spc., Amaranthus viridis, Euphorbia hypericifolia, dinebra spp., and Euphorbia microphylla weeds than when treated with the compositions without electrolyte and non-ionic surfactant or with the compositions having either of electrolyte or non-ionic surfactant.

The agrochemical composition for improving the effectiveness of an herbicide developed according to the present invention resulted into an efficacious composition. The combination of non-ionic surfactant and an electrolyte successfully improved absorption and uptake of herbicide which resulted into an increased efficacy. The careful selection of the non-ionic surfactant and electrolyte in formulating an agrochemical composition provided excellent efficacy onto crops. It is to be understood that the invention is not to be limited to the details of the above embodiments, which are described by way of example only. Many variations are possible.

1. An agrochemical composition for improving the effectiveness of an herbicide comprising: a) at least one herbicide, its salt, isomer or derivative; b) at least one non-ionic surfactant; and c) at least one electrolyte.

2. The agrochemical composition as claimed in claim 1, wherein the herbicide comprises a) an organophosphorous herbicide; b) a nitrophenyl ether compound; c) an aryloxyphenoxypropionic herbicide; d) a chloroacetanilide herbicide; a e) sulfonylurea herbicide; f) an imidazolinone herbicide, or a combination thereof.

3. The agrochemical composition as claimed in claim 1, wherein the herbicide is glufosinate, a salt, an isomer, or a derivative thereof.

4. The agrochemical composition as claimed in claim 3, wherein the glufosinate is glufosinate ammonium, glufosinate sodium, d-glufosinate, or 1-glufosinate.

5. The agrochemical composition as claimed in claim 1, wherein the herbicide is glyphosate, a salt, or derivative thereof.

6. The agrochemical composition as claimed in claim 5, wherein the glyphosate salt is glyphosate isopropyl ammonium.

7. The agrochemical composition as claimed in claim 1, wherein non-ionic surfactant comprises alcohol ethoxylate, alkylpolyglucoside, alkylamine oxide, alkyl glucamide, fatty acid methyl ester, sorbitan ester and ethoxylated sorbitan ester, ethoxylated alkylphenol, ethoxylated tristyrylphenol, alkyl amide, or a mixture thereof.

8. The agrochemical composition as claimed in claim 7, wherein the non-ionic surfactant comprises d-glucitol, 1-deoxy-1-(methylamino)-,N—C8-10 acyl derivatives; capryloyl/caproyl methyl glucamide, polysorbate 80, nonylphenol ethoxylated, castor oil ethoxylated fatty acids, decylglucoside (C9-11 alkyl polyglucoside), caprylyl/capryl glucoside, cocoglucoside, decylamine oxide, myristylamine/dimethylamine oxide, or a mixture thereof.

9. The agrochemical composition as claimed in claim 1, wherein the electrolyte comprises an alkali or alkaline earth metal salt.

10. The agrochemical composition as claimed in claim 9, wherein the electrolyte comprises magnesium chloride, magnesium sulfate, potassium chloride, potassium sulfate, sodium chloride, sodium carbonate, sodium chlorate, sodium nitrate, sodium sulfate, calcium chloride, calcium carbonate, calcium nitrate, or a combination thereof.

11. The agrochemical composition as claimed in claim 1, further comprising anionic surfactant, wherein the anionic surfactant comprises linear alkylbenzene sulfonates, alkyl ester sulfonates, alkyl sulfates, alkyl alkoxy sulfates, alkyl sulfonates, alkyl aryl ether sulfates, alkyl napthalene sulfonates, sulfosuccinates, and taurates, as well as mixtures thereof, preferably sodium laureth sulfate, sodium lauryl sulfate, sodium lignosulfonate, sodium dodecyl benzenesulfonate, naphthalene sulfonate condensate, or a combination thereof.

12. A method of controlling undesirable plants, said method comprising applying to the plants or to their locus, an herbicidally effective amount of an agrochemical composition comprising at least one herbicide, its salt, isomer or derivative; at least one non-ionic surfactant; and at least one electrolyte, wherein the composition improves the effectiveness of an herbicide.

13. The method of controlling undesirable plants as claimed in claim 12, wherein the herbicide is glufosinate.
